(19) United States
(12) Patent Application Publication
(10) Pub. No.: US 2024/0380822 A1
(43) Pub. Date: Nov. 14, 2024

(54) MULTI-MODAL HYPERGRAPH-BASED CLICK PREDICTION

(71) Applicant: eBay Inc., San Jose, CA (US)

(72) Inventors: Dingxian WANG, Newcastle, WA (US); Guandong XU, Oatley (AU); Hongxu CHEN, Ryde (AU); Li HE, Beijing (CN)

(21) Appl. No.: 18/569,132

(22) PCT Filed: Aug. 26, 2021
(86) PCT No.: PCT/CN2021/114732

§ 371 Date: Dec. 11, 2023

(51) Int. Cl. H04L 67/50; G06F 16/735

(52) U.S. Cl. CPC H04L 67/535; G06F 16/735

(57) ABSTRACT

One of the important signals that online platforms rely upon is the click-through rate prediction. This allows a platform, such as a video platform, to provide items, such as videos, to users based on how likely the user is to interact with the item. A hypergraph model is provided to exploit the temporal user-item interactions to guide the representation learning with multi-modal features, and further predict the user click-through rate of an item. The hypergraph model is built upon the hyperedge notion of hypergraph neural networks. In this way, item modalities, such as visual, acoustic, and textual aspects can be used to enhance the click-through rate prediction and, thus, enhance the likelihood that the online platform will provide relevant content. The technology leverages hypergraphs, including interest-based hypergraphs and item hypergraphs that uniquely provide the relationship between user and items. The hypergraph model described demonstrably outperforms various state-of-the-art methods.

### BACKGROUND OF THE INVENTION

Many online services, including video streaming services, offer content to users. These services seek to provide content that is relevant to the users. For instance, an online streaming service might provide a continuous stream where videos are provided to the user one after another. In cases like this, the service provider will continually try to offer relevant content so that the user is able to maximize the use of the service.

In recent years, online video service platforms have changed to meet the demands of a different type of viewer. In the past, large streaming services offered lengthy video streams of content. For example, a video streaming service would provide users a library of movies. When the user watched a movie, the user's engagement was based on the content of the movie, and the user generally remained engaged during one or two session for the entire duration of the movie.

Today, the video streaming landscape has shifted. Now, services are more likely to host a much larger library of shorter videos, many of which are only fifteen to thirty seconds long and are uploaded by other users. These services usually provide users a way to interact with the videos, through either likes, comments, shares, or some other form of interaction. Today's streaming services look to these interactions to attempt to learn the user so that the service can continually provide relevant content in which the user is interested.

However, the shift from small libraries of lengthy video content to vast and amorphous libraries of short video content, which may also be referred to as micro-videos, has created problems for video service provides to be able to learn users, and to identify and provide users with content from an ever-changing and ever-growing video library.

### SUMMARY OF THE INVENTION

At a high level, aspects described herein relate to methods for identifying and providing items, such as video content, based on determining a click prediction for the content using hypergraphs and a hypergraph neural network.

One method involves obtaining a sequence of user interactions where the user has interacted with an item, such as a video, being provided by online platform. The sequence provides the temporal order of the items with which the user has interacted. The sequence of user interactions for a time slot or series of time slots is provided to an attention layer that outputs a sequential user representation.

From the sequence of user interactions, a series of hypergraphs is generated. The hypergraphs include interest-based user hypergraphs comprising user correlations based on common user content interests for content of the video platform. The hypergraphs also include item hypergraphs comprising item correlations between users and a plurality of item modalities for the items the users have interacted with in the video platform.

The interest-based user hypergraphs and the item hypergraphs are input into a hypergraph neural network to output a group-aware user. The group-aware user's representation, an embedded representation of the group-aware user, is fused with the sequential user representation to provide a first embedded fusion. Meanwhile, a target item representation, e.g., an embedded representation of a candidate item that may be provided to the user and an item-item hypergraph embedding from an output of the hypergraph neural network are combined to provide a combined embedding.

The first embedded fusion and the combined embedding are input into a multilayer perceptron (MLP) that is configured to output the click-through rate probability. The click-through rate probability can be used to select the target item and provide it to a user.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWING

The present technology is described in detail below with reference to the attached drawing figures, wherein:

FIG. 1 is an example operating environment for a video platform in which aspects of the disclosure can be employed, in accordance with an embodiment described herein;

FIG. 2 is an example item providing engine that may be employed by components of FIG. 1, including the video platform, in accordance with an embodiment described herein;

FIG. 3 is an example hypergraph click-through rate prediction model that may be employed by the item providing engine of FIG. 2, in accordance with an aspect described herein;

FIG. 4 is a block diagram illustrating an example method for determining a click-through rate probability using the item providing engine of FIG. 2, in accordance with an aspect described herein;

FIG. 5 is block diagram illustrating an example method for receiving a target item from the item providing engine of FIG. 2; and

FIG. 6 is an example computing device suitable for implementing the described technology, in accordance with an embodiment described herein.

### DETAILED DESCRIPTION OF THE INVENTION

As noted, the transition from small video libraries of lengthy videos to vast libraries of relatively shorter videos has brought about particular challenges. In particular, as the average length of videos on a video platform decrease, the number of videos that are needed to fill the same length of time increases. This places more emphasis on how videos are selected. For instance, in early 2021, a popular micro-video platform, TikTok, had more than two billion video downloads. Even more significant, TikTok was experiencing more than one billion video views each day.

Given the number of available videos and the need to constantly identify relevant videos for users from the vast libraries, new technology is needed. That is because it would be impossible for a person to actively select, much less identify, videos from such a large library that the user finds as significant. Thus, new technology is needed to identify users, learn the users, and then use that knowledge to identify videos and provide them to the user.

Identification of videos relevant to users is not a simple or straightforward problem to solve. The size and content of the library is rapidly changing. Further, certain datasets lack much of the information about users needed to successfully identify relevant content. Moreover, when some information about a user is known, that information might not be specific enough to narrow down the field of possible candidate videos from an enormous library. As an example, if a user is known to like sports videos, the potential candidate sports videos might still number in the tens or hundreds of millions. Determining which of the millions of relevant videos to select is still a challenge. Another selection problem arises when trying to identify other related content. The user could be presented with a continuous stream of the sports videos, but doing so might fail to identify any other interest areas and videos relevant to those interests. Without some additional learning, the user might be presented with only one type of video, given that there are a large number of similar videos in a platform hosting two plus billion videos.

Thus, to be able to effectively utilize these types of video platforms, methods for learning the user and identifying videos based on the learning are needed. Otherwise, these types of platforms would be limited in the number of videos they could host. The present disclosure provides methods that more effectively learn users, and identify and provide videos in a manner more effective than conventional systems, such as those that use other artificial intelligence methods or other database recall methods, such as tagging and indexing.

For instance, conventional methods such as these do not take into account learning based on modalities, e.g., different aspects of a video, such as the acoustic, visual, and textual features of the video. The conventional methods all suffer from sparsity problems to a much higher degree than the methods provided by this disclosure that use hypergraph neural networks for video identification and recall. For instance, when typically identifying and recalling a video based on how likely the user is to engage in the video, the interactions between users and the videos are normally sparse. That is because a user might watch a video and not interact with it, or may only interact with it to a limited degree, such as indicating the user “likes” the video. Conventional methods have been hesitant to utilize various modalities for predicting a user's interaction or engagement with a video because doing so only compounds the sparsity issue. As an example, when attempting to account for three modalities that include acoustic, visual, or textual aspects of a video, the sparsity of the dataset is tripled.

To mitigate this issue, the present disclosure provides for methods that include hypergraph generation and using a hypergraph neural network to learn the how likely the user is to interact with a particular target video. Performance of the models has been shown to effectively mitigate the sparsity issue and better predict whether a user will interact with a target when compared to previous methods, as will be described in examples provided by this disclosure. In effect, this allows a system to be able to retrieve and provide videos from larger libraries. Using hypergraphs can more accurately predict the user's interaction with the next video with less data, thereby making it easier for systems to maintain and use larger libraries, and making it easier to host video platforms having relatively shorter video clips.

One such method that achieves these benefits, among others that will be described in additional detail, uses hypergraphs. A hypergraph comprises a generalized graph that includes edges joining any number of nodes or vertices. Different types of hypergraphs can be generated to show various relationships between users and items relative to areas of the hypergraph that are defined by hyperedges. As used herein, the term “item” is intended to refer to information that comprises more than one modality, including a video, which can include one or more textual, visual, and acoustic modalities. Thus, how a user interacts with items can be analyzed using hypergraphs and a hypergraph neural network to predict how likely the user is to interact with another item, and this prediction can be used to select and provide items, such as videos, to the user.

To briefly illustrate one aspect that will be further described, user interactions with items can be identified. For instance, a user that is using a video platform might view an item and may interact with it by “liking” it, commenting on it, sharing it, and so forth. The user is presented a series of items and the sequence of items from the series with which the user interacts can be identified as the user's interaction sequence. The user interaction sequence can be truncated so that it includes only a portion of the sequence within a time slot. Time slots can be adjusted to include relatively more recent interactions, indicating more current user interactions and trends, or adjusted to capture seasonal variations, such as a similar time the previous year.

From the user interactions, interest-based user hypergraphs or item hypergraphs can be generated. Interest-based user hypergraphs can be generated with group-aware hyperedges of areas comprising a group of users connected by one unimodal feature within each hyperedge. Using the interest-based hypergraphs, item hypergraphs can be generated based on a set of items with which each user has interacted such that item nodes are linked to users having interacted with the items represented by the item nodes. Within the item hypergraphs, each item node can map to several users, while each user also has multiple interactions with various items. Thus, item information can be clustered to build item hyperedges so that there are several layers for each modality, each extending from interests-based user hyperedges. In general, the item hypergraphs having group-aware hyperedges capture a group member's preference, while the item hypergraphs provide an item-level high-order representation.

The interest-based user hypergraphs and the item hypergraphs can be provided to a hypergraphs neural network, such as a hypergraph convolutional network. The hypergraph neural network operators learn local and high-order structural relationships and output these as a group aware. The embedded representation of the group-aware user can be fused though an infusion layer with a sequential user representation that is an embedded representation of sequential user interactions.

The resulting output through the fusion layer, the fused sequential user representation and the group-aware user representation, is provided as an input to a multilayer perceptron (MLP) along with an embedded representation of a target item and an item-item hypergraph embedding from the output of the hypergraph neural network. The output of the MLP provides the probability (i.e., the click-through rate prediction) that the user will interact with the target item. The target item may be selected among other items to provide to the user based on the click-through rate prediction that the user will click on the item.

It will be realized that the method previously described is only an example that can be practiced from the description that follows, and it is provided to more easily understand the technology and recognize its benefits. Additional examples are now described with reference to the figures.

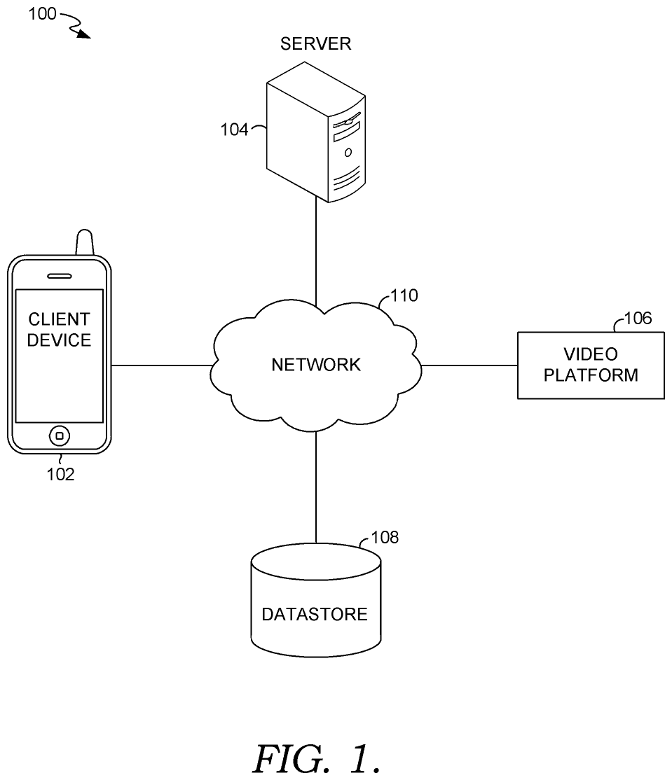

With reference first to FIG. 1, among other components or engines not shown, operating environment 100 includes client device 102, server 104, video platform 106 and datastore 108, each of which is shown communicating using network 110.

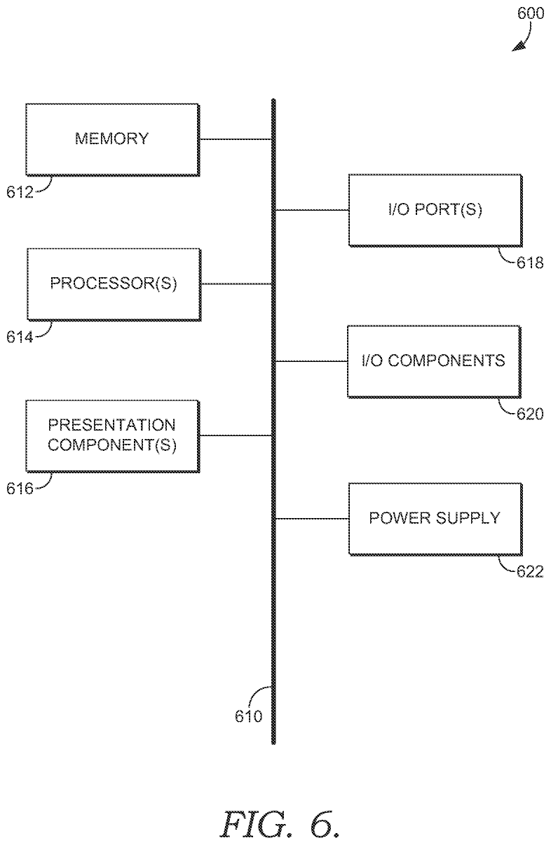

In general, client device 102 may be any type of computing device, such as computing device 600 described with reference to FIG. 6. As example, client device 102 may take the form of a mobile device, such as a smartphone, tablet, internet of things (IoT) device, smartwatch, and the like. In general, client device 102 may receive inputs via an input component and communicate received inputs to other components of FIG. 1. Moreover, client device 102 may receive information from other components of FIG. 1 and provide that information to a user via an output component. Some example input/output components that may be utilized by client device 102 are described with reference to FIG. 6. Client device 102 may also represent one or more client devices. In an implementation, client device 102 receives inputs associated with user interactions with a video being provided by video platform 106, and it provides the user interactions to video platform 106, which will be discussed in more detail. In some implementations, client device 102 may be referred to as a client-side device and may perform operations on the client-side.

Server 104 may be any computing device, and like other components of FIG. 1, represents one or more servers. An example computing device 600 is provided with respect to FIG. 6 and is generally suitable as server 104. Server 104 is generally configured to execute aspects of video platform 106. In some cases, server 106 may be referred to as a back-end server and perform operations on the server side.

Video platform 106 is also illustrated as part of operating environment 100. In general, video platform 106 is a video service provider that provides client device 102 with access to videos. Video platform 106 may include a web-based video streaming platform that may permit users to upload and view videos. In this way, one user can stream a video uploaded by another user. Video platform 106, among other video types, comprises a micro-video platform that generally hosts relatively short length videos. As an example, micro-videos may be anywhere from fifteen to thirty seconds in length. Video platform 106 may provide a series of streamed videos. This can include a continuous stream of two or more videos that are played sequentially for the users. Aspects of video platform 106 may be performed by any computing device in network 100, including being performed on the client side by client device 102 or the server side by server 104, in any combination.

Operating environment 100 comprises datastore 108. Datastore 108 generally stores information including data, computer instructions (e.g., software program instructions, routines, or services), or models used in embodiments of the described technologies. Although depicted as a single database component, datastore 108 may be embodied as one or more data stores or may be in the cloud. In aspects, datastore 108 will store data received from client device 102 or server 104, and my provide client device 102 or server 104 with stored information. Datastore 108 can be configured to store functional aspects, including computer-executable instructions, that perform functions of video platform 106 that will be further described.

As noted, components of FIG. 1 communicate via network 110. Network 110 may include one or more networks (e.g., public network or virtual private network “VPN”) as shown with network 110. Network 110 may include, without limitation, one or more local area networks (LANs) wide area networks (WANs), or any other communication network or method.

Having identified various components of operating environment 100, it is noted and again emphasized that any additional or fewer components, in any arrangement, may be employed to achieve the desired functionality within the scope of the present disclosure. Although some components of FIG. 1 are depicted as single components, the depictions are intended as examples in nature and in number and are not to be construed as limiting for all implementations of the present disclosure. Other arrangements and elements (e.g., machines, interfaces, functions, orders, and groupings of functions, etc.) can be used in addition to or instead of those shown, and some elements may be omitted altogether.

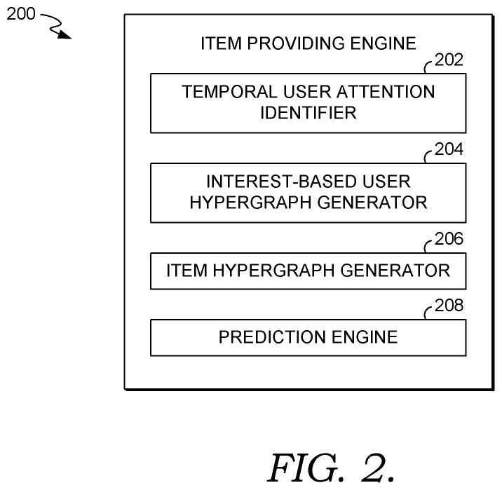

Turning now to FIG. 2, an example item providing engine 200 is illustrated. Item providing engine 200 may be utilized by video platform 106 of FIG. 1 to identify and provide items to client device 102. As noted, “items” include content that can be pushed to client device 102 and include videos that can be provided to and displayed at client device 102. Thus, item providing engine 200 provides one example by which video platform 106 can utilize hypergraph neural networks to determine a click-through rate prediction for a target item so that the target item is provided at client device 102. The target item may be identified as relevant to the user and provided to the user as part of a continuous video stream.

Many of the elements described in relation to FIG. 2, such as those described in relation to item providing engine 200, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory. Moreover, the functions described in relation to FIG. 2 may be performed by client device 102 or server 104 in any combination.

To determine the click-through rate prediction that can be used to identify and provide items, item providing engine 200 employs temporal user attention identifier 202, interest-based user hypergraph generator 204, item hypergraph generator, 206, and prediction engine 208.

As noted and as will be further described, item providing engine 200 may learn user preferences using hypergraphs to predict the click-through rate probability. As will be utilized throughout this disclosure, and referenced to throughout the discussion, U represents a set of users and I represents a set of P items in an online video platform. The interaction between item modalities and user interactions can be represented as a hypergraph [symbol] (u,i), where u∈U and i∈I separately denote the user and item sets, respectively. A hyperedge, [symbol] (u,i₁,i₂,i₃, . . . ,iₙ) indicates an observed interaction between user u and multiple items (i₁,i₂,i₃, . . . ,iₙ) where the hyperedge is assigned with a weight by W, which can include a diagonal matrix of edge weights. There is also multi-modal information associated with each item, such as visual, acoustic and textual features. As such, M−{v,a,x} is denoted as the multi-modal tuple, where v, a, and x represent the visual, acoustic, and textual modalities, respectively.

A user group y is associated with a user set C_{y}∈U which can be used to represent an N-dimensional group-aware embedding. For each user u, the user's temporal behavior is denoted as Bᵤ^{c} responding to the current time, and sequential view user behavior as Bᵤ^{s} according to a time slot. [symbol] (Bᵤ^{c}) and [symbol] (Bᵤ^{s}) are utilized to represent the set of items in the sequential behavior, respectively.

With continued reference to FIG. 2, temporal user attention identifier 202 is configured to identify user interaction sequences associated with items for a user of a video platform. As noted, a user may utilize a video platform to receive and view items at a client device, such as client device 102 of FIG. 1. The user may interact with the items, such as a video, by performing any one of a number of different interactions, such as liking, commenting, sharing, editing, clicking, downloading, following, and so forth. Over time, the user does this for more than one item, providing a sequence of interactions for items with which the user has interacted. For instance, over time, the user may view numerous items and interact with only some of the items. The user interaction sequence can comprise the items with which the user has interacted and exclude those with which the user has not interacted. The user interaction sequence can provide a temporal sequence of the items with which the user has interacted. That is, the items in the user interaction sequence may be temporally ordered based on a timestamp for each item indicating when the user interacted with the item. This pattern illustrates the user's interest over time.

Temporal user attention identifier 202 can be configured to identify user interactions within time slots. A time slot may represent a particular period of time, and can be defined for any length of time. The time slot may also be defined based on the number of user interactions occurring within the time slot. As an example, each time slot may comprise a specific number of items with which the user has interacted. For example, each time slot may comprise a sequence of ten items. It will be realized that this number may be set to any number and adjusted based on the computational capabilities of the computing device that is determining the click-through rate, as increasing the number of items in a user interaction sequence increases the processing demands of the machine. Said another way, the user interaction sequences can be truncated based on the timestamp so that the user interactions are included within a defined time slot. Sequential time slots can capture user interaction sequences. That is, a first slot can capture a first user interaction sequence and a second time slot that temporally follows the first time slot can capture a second user interaction sequence and so forth.

The user interactions can be represented according to the following: Let a sequence [symbol] (u,i₁,i₂,i₃, . . . ) indicate an observed interaction between user u and multiple items (i₁,i₂,i₃, . . . ) occurring during a time slot tₙ, such as time slot 308. E_{I}=[e₁,e₂ . . . ] is then denoted as the set of items' static latent embeddings, which represents the set of items a user interacts with during this time slot. Each item in current sequence is associated with multi-modal features, which utilize Mᵢ_{ₙ}, and it contains three-fold information about visual, acoustic and textual aspects, denoted as vᵢ_{ₙ}, aᵢ_{ₙ} and xᵢ_{_{n′}} respectively.

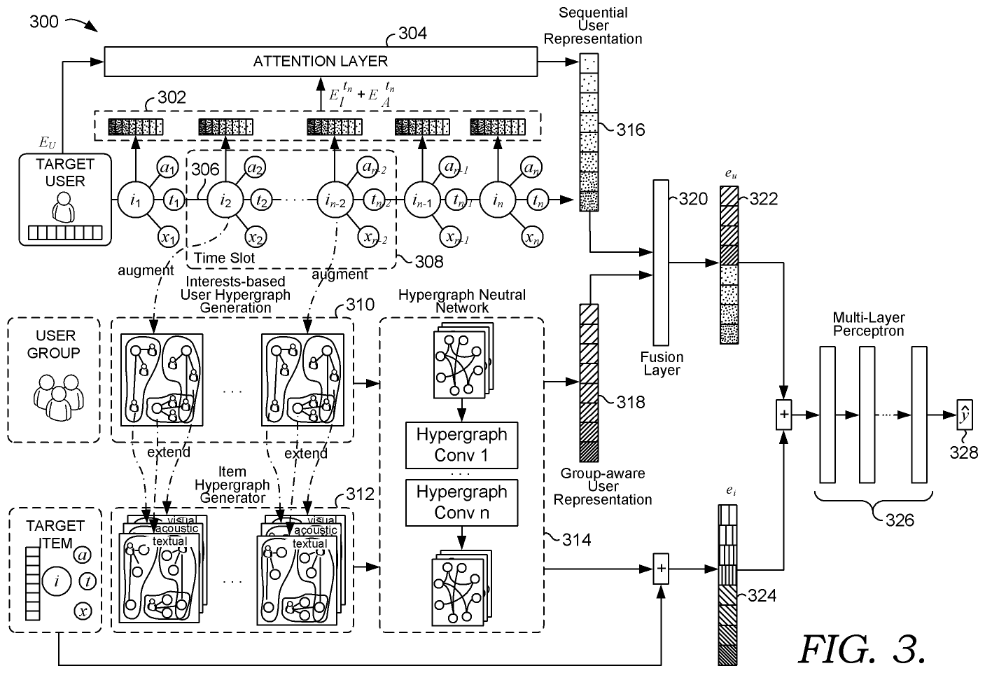

Referencing also now FIG. 3, the figure illustrates an example hypergraph click-through rate prediction model 300 that can be utilized by item providing engine 200. Temporal user attention identifier 202 may identify user interactions and can access embedding layer 302 and attention layer 304 of model 300.

Using embedding layer 302, as depicted in FIG. 3, the long-term user interaction can be represented by all the items the user has interacted with in a certain time slot tₙ. In the user embedding mapping stage, to depict user behavior features, users' metadata and profiles are used to define an embedding matrix E_{U} for each user uⱼ. Further, an item embedding matrix M₁ ∈ [symbol] ^{|l|×d} and a multi-modal attribute embedding matrix M_{A}∈ [symbol] are maintained. The two matrices project the high-dimensional one-hot representation of an item or multi-modal attribute to low-dimensional dense representations. Given a l-length time granularity sequence, a time-aware slot window is applied to form the input item embedding matrix E_{I}^{t}^{ₙ}∈ [symbol] ^{I×d}. An embedding matrix E_{A}^{t}^{ₙ}∈ [symbol] ^{k×d} is also formed for each item from the multi-modality attribute embedding matrix M_{A}, where k is the number of item modalities. The sequential sequence representation E^{t}^{ₙ}∈ [symbol] ^{n×d} can be obtained by summing three embedding matrices: E^{t}^{ₙ}==E_{U}+E_{I}^{t}^{ₙ}+E_{A}^{t}^{ₙ}.

Attention layer 304 employs a sequential user behavior encoder to output an embedded sequential user representation. In FIG. 3, an example of this is illustrated by sequential user representation 316. Attention layer 304 can be a self-attention layer comprising a transformer applied in time series prediction. The self-attention is the basic model to capture the temporal pattern in user-items interaction sequence 306. A self-attention module generally uses two sub-layers, i.e., a multi-head self-attention layer and a point-wise feed-forward network. The multi-head self-attention mechanism can be used for effectively extracting the information selectively from different representation subspaces. The multi-head self-attention is defined as:

$$\begin{matrix}MultiHead ( Q , K , V ) = Concat ( {head}_{1} , … , {head}_{h} ) {W}^{0} & ( 1 ) \\ {head}_{i} = Attetion ( {QW}_{i}^{Q} , {KW}_{i}^{K} , {VW}_{i}^{V} ) & ( 2 )\end{matrix}$$

Where the projections are parameter matrices Wᵢ^{Q}∈ [symbol] ^{d×d}^{ₖ}, Wᵢ^{K}∈ [symbol] ^{d×d}^{ₖ}, Wᵢ^{V}∈ [symbol] ^{d×d}^{ᵥ} and W^{O}∈ [symbol] ^{hd}^{ᵥ}^{×d}. The attention function is implemented by scaled dot-product operation:

$$Attention ( Q , K , V ) = softmax ( \frac{{QK}^{T}}{\sqrt{{d}_{k}}} ) V \qquad ( 3 )$$

where (Q=K=V)=E are the linear transformations of the input embedding matrix, and

$$\frac{1}{\sqrt{{d}_{k}}}$$

is the scale factor to avoid large values of the inner product, since the multi-head attention module is mainly build on the linear projections. In addition to attention sub-layers, a fully connected feed-forward network that contains two linear transformations with a ReLU (Rectified Linear Unit) activation in between is applied.

$$FFN ( x ) = ReLU ( 0 , {xW}_{1} + {b}_{1} ) {W}_{2} + {b}_{2} \qquad ( 4 )$$

where W₁, b₁, W₂, b₂ are trainable parameters.

At each time slot, the correlations among users and items can be more complex than pairwise relationship, which is difficult to be modeled by a graph structure. On the other hand, the data representation tends to be multi-modal, such as the visual, text and social connections. To achieve that, each user connects with multiple items with various modality attributes, while each item correlates with several users. This naturally fits the assumption of the hypergraph structure for data modeling. A hypergraph can encode high-order data correlation using its degree-free hyperedges. [symbol] (u,i) is constructed to present user-item interactions over different time slots. Then, hyperedges can be distilled to build user interest-based hypergraph [symbol] _{g}^{t}^{ₙ} and item hypergraph [symbol] ᵢ^{t}^{ₙ} to aggregate high-order information from all neighborhoods. The hyperedge groups are concatenated to generate the hypergraph adjacent matrix H. The hypergraph adjacent matrix H and the node feature are fed into a convolutional neural network (CNN) to get the node output representations. A hyperedge convolutional layer ƒ(X,W,Θ) can be built as follows:

$${X}^{( l + 1 )} = σ ( {D}_{v}^{- 1 / 2} {HWD}_{e}^{- 1} {H}^{T} {D}_{v}^{- 1 / 2} {X}^{( l )} {Θ}^{( l )} ) \qquad 5 )$$

where define X, Dᵥ, Dₑ and Θ is the signal of hypergraph at l layer, σ denotes the nonlinear activation function. The GNN (Graph Neural Networks) model is based on the spectral convolution on the hypergraph.

Now, both user sequential embeddings and group-aware high-order information can be incorporated for a more expressive representation of each user in the sequence. A fusion layer can generate the representation of user u at tₙ. One fusion process suitable for use in the present model transforms the input representations into a heterogeneous tensor. The user sequential embedding E^{t}^{ₙ} and group-aware hypergraph embedding E_{g}^{t}^{ₙ} are used here. Each vector E is augmented with an additional feature of constant value equal to 1, denoted as E=(E, 1)^{T}. The augmented matrix E is projected into a multi-dimensional latent vector space by a parameter matrix W, denoted as W^{T}Eₘ. Therefore, each possible multiple feature interaction between user and group-level is computed via outer product, [symbol] =ƒ(W^{T}·\tilde{E}ₘ), expressed as:

$${𝒯}_{U} = {W}^{T} ( {E}^{{t}_{n}} ⊗ {E}_{g}^{{t}_{n}} ) \qquad ( 6 )$$

Here ⊗ denotes outer product, E_{\tilde{m}} is the input representation from user and group level. It is a two-fold heterogeneous user-aspect tensor [symbol] _{U}, modeling all possible interrelation, i.e., user-item sequential outcome embeddings E^{t}^{ₙ} and group-aware aggregation features E_{g}^{t}^{ₙ}.

When determining the click-through prediction of users for items, both sequential user embedding and item embedding are taken into consideration. The user-level probability score y to a candidate item i, is calculated to clearly show how the function ƒ works. The final estimation for the user click-through probability prediction probability is calculated as:

$$\hat{y} = f ( {e}_{u} , {e}_{i} ; Θ ) \qquad 7 )$$

where eᵤ and eᵢ denote user and item-level embeddings, respectively. ƒ is the learned function with parameter Θ and implemented as a multi-layer deep network with three layers, whose widths are denoted as {D₁, D₂, . . . , D_{N}} respectively. The first and second layer use ReLU as activation function while the last layer uses sigmoid function as Sigmoid

$$( x ) = \frac{1}{1 + {e}^{- x}} .$$

As for the loss function, cross entropy loss can be utilized. It can be formulated as:

$$L ( {e}_{u} , {e}_{i} ) = y log σ ( f ( {e}_{u} , {e}_{i} ) ) + ( 1 - y ) log ( 1 - σ ( f ( {e}_{u} , {e}_{i} ) ) ) \qquad ( 8 )$$

where y∈{0, 1} is ground-truth that indicates whether the user clicks the micro-video or not, and ƒ represents the multi-layer deep network.

Interest-based user hypergraph generator 204 generally generates Interest-based user hypergraphs based on the user interaction sequences. Interest-based user hypergraphs, such as those illustrated by interest-based user hypergraphs 310, can be generated for users of a user group. The interest-based hypergraphs may comprise user correlations based on common user content interest for content of the video platform.

From the group-level aspect, most items correlate to more than one user. That is because various different users of a user group may have interacted with the same item. Item information can be extracted from user interaction histories. Using the extracted item information, which may include the item, its modalities, and users that have interacted with the item, group-aware hyperedges can be generated. As illustrated in FIG. 3, there are three different areas within the interest-based hypergraphs. An interest-based hypergraph can be generated for a plurality of time slots. In a particular user case, the interest-based hypergraphs are generated from each time slot in a series of sequential time slots.

Within the interest-based hypergraph, each area denotes a hyperedge and a group of users connected by one unimodal feature in each hyperedge. This is called an interest-based user hyperedge, and the task is to learn a user-interest matrix, leading to construct the hyperedges. Each interest-based user hypergraph is generated to represent a group of users interacting with the same item in the current time, where altogether the users have different tendencies. From this, the group-aware information to enhance individual's representation can be learned. Here, there is the opportunity to infer the preference of each user to make the prediction more accurate.

In generating interest-based user hypergraphs, let [symbol] _{g}^{t}^{ₙ} represent a hypergraph associated with i-th item at time slot tₙ. [symbol] _{g}^{t}^{ₙ}={V_{g}^{t}^{ₙ}, [symbol] _{g}^{t}^{ₙ},W_{g}^{t}^{ₙ},H_{g}^{t}^{ₙ}} is constructed based on the whole user-item interactions with multi-modal information. V_{g}^{t}^{ₙ} represents the nodes of individual and the correlated item in [symbol] _{g}^{t}^{ₙ}, [symbol] _{g}^{t}^{ₙ} denoted as a set of hyperedges. Thus, a link to users who have interactions with multiple modal lists of items is created. Each [symbol] _{g}^{t}^{ₙ} is associated with an incidence matrix H_{g}^{t}^{ₙ} and it is also associated with a matrix W_{g}^{t}^{ₙ}, which can be a diagonal matrix representing the weight of the hyperedge [symbol] _{g}^{t}^{ₙ}.

Self-supervised learning for the user-interest matrix F∈ [symbol] ^{L×d} is used. Here, L denotes the user counts and d denotes the number of multi-modalities according to items. The weights {θₐ,θ_{b},θ_{c}} for each modalities are then trained. {α,β,γ} can be defined to denote a degree of interest of each modalities from the item features. A threshold δ can be applied to measure which modality contributes the most for user-item interaction. The mutual information between users u and items multi-modal attributes Mᵢ_{ᵢ}^{t}^{ₙ} is maximized.

For each user and item, metadata and attributes provide fine-grained information about them. User and multimodal-level information through modeling user-multimodal correlation are fused. In this way, useful multi-modal information is injected into user group representations. Given an item i and the multi-modal attributes embedding matrix Mᵢ_{ᵢ}^{t}^{ₙ}∈ [symbol] , user, item, and its associated attributes are treated as three different views and denoted as E_{U},E_{I}^{t}^{ₙ} and E_{A}^{t}^{ₙ}. Each E_{A}^{t}^{ₙ} is associated with a embedding matrix Mₖ∈Mᵢ_{ₙ}^{t}^{ₙ}={vᵢ_{ₙ}^{t}^{ₙ},aᵢ_{ₙ}^{t}^{ₙ},xᵢ_{ₙ}^{t}^{ₙ}}. A loss function can be designed by the contrastive learning framework that maximizes the mutual information between the three views. Following Equation 8, the User Interest Prediction (UIP) loss is minimized by:

$${L}_{UIP} = ( u , i , {E}_{{A}_{i}} ) = {𝔼}_{{j}_{I} ∈ {E}_{{A}_{i}}} [ f ( u , i , {a}_{j} ) - log {\sum }_{\tilde{a} ∈ {E}_{A} / {E}_{{A}_{i}}} exp ( f ( u , i , \tilde{a} ) ) ] \qquad ( 9 )$$

where negative attributes ã that enhance the association among users are sampled, and item and the ground-truth multi-modal attributes, “\” defines set subtraction operation. The function ƒ(⋅,⋅,⋅) can be implemented with a simple bilinear network:

$$f ( u , i , {a}_{j} ) = σ ⌊ ( {E}_{l}^{T} \cdot {W}_{UIP} \cdot {E}_{{A}_{i}} ) \cdot {E}_{U} ⌋ \qquad 10 )$$

where W_{UIP}∈ [symbol] ^{d×d} is a parameter matrix to learn and σ(⋅) is the sigmoid function. The loss function L_{UIP} for a single user is defined, which can be extended over the user set. The outcome from ƒ(⋅) for each user can be constructed as a user-interest matrix F and compared with the threshold δ to output the L-dimensions vector v∈ [symbol] ^{1×L}.

Item hypergraph generator 206 generates item hypergraphs. Item hypergraphs can be generated for users of a user group of the online video platform. In generating the item hypergraphs, each item hypergraph can comprise item correlations between users and a plurality of item modalities for the items with which the users have interacted. Item hypergraphs may be generated in layers, such that each layer represents a different modality. In one specific aspect, each hyperedge is associated with a user and each user is associated with the items with which the user has interacted.

To give an example, there is a hyperedge in each [symbol] ₙ^{t}^{ₙ} modality, e.g., three in the case of visual, acoustic, and textual modalities. Continuing with this example, let [symbol] ᵢ^{t}^{ₙ}( [symbol] ᵢ^{t}^{ₙ}⊇{gᵥ^{t}^{ₙ},gₐ^{t}^{ₙ},gₓ^{t}^{ₙ}}) represent a series of item homogeneous hypergraphs for each user group member. [symbol] ᵢ^{t}^{ₙ}={Vᵢ^{t}^{ₙ}, [symbol] ᵢ^{t}^{ₙ}Wᵢ^{t}^{ₙ},Hᵢ^{t}^{ₙ}} is constructed based on each [symbol] ᵢ^{t}^{ₙ} and describes a set of items that a user interacts with generated in the time slot tₙ. Vᵢ^{t}^{ₙ} represents the nodes of items, and [symbol] ᵢ^{t}^{ₙ} denotes a set of hyperedges, which is creating the link to items which have interactions with a user.

Sequential user-item interactions can be transformed into a set of homogeneous item-level hypergraphs. A set of homogeneous hypergraphs [symbol] _{I} is constructed from node sets I as follows:

$${𝒢}_{I} = \{ {𝒢}_{I , group} , {𝒢}_{I , 1} , … , {𝒢}_{I , Q} \} \qquad 11 )$$

where [symbol] _{I,j}={I [symbol] _{I,j}}, and [symbol] _{I,j} denote hyperedges in [symbol] _{I,j}. In this example, all of the homogeneous hypergraphs in [symbol] _{I} share the same node set I. For a node i∈I, a hyperedge introduced in [symbol] _{I,j} of [symbol] _{I,j}, which connects to {i|i∈I,(u,i)}∈ [symbol] _{T}_{ₙ}, i.e., the vertices in I that are directly connected to u by [symbol] _{T}_{ₙ} in time period Tₙ. In the user-item sequential interaction network, the user u clicks three items v, which correspond to a hyperedge that connects these three items in the homogeneous hypergraph [symbol] _{I}. The special homogeneous hypergraph [symbol] _{I,group}∈ [symbol] _{I} are defined as G(I,∪ⱼ₌₁^{k} [symbol] _{I,j}). Note that the cardinalities of hyperedge sets in the constructed hypergraph can be expressed as: | [symbol] _{I,j}|≤|U| and | [symbol] _{I,group}|≤k|U| for j≤k. The total number of hyperedges in the homo-hypergraph is generally proportional to the number of nodes and edge types in the input sequence: O(k(|I|+|V|)). This allows the transformation to easily scale to large inputs.

Prediction engine 208 generally predicts the click-through rate using the interest based hypergraphs and the item hypergraphs. Prediction engine 208 receives the output of the interest-based user hypergraphs and the item hypergraphs that have been fed into a hypergraph neural network. In the illustration provided by FIG. 3, interests-based user hypergraphs 310 and item hypergraphs 312 are fed into hypergraph neural network 314, the output of which is a group-aware representation. In this way, prediction engine 208 may generate group-aware user representations, which can be an embedded representation of the group-aware user.

As noted, an output of an attention layer is a sequential user representation. In the example provided by FIG. 3, the output of attention layer 304 is sequential user representation 316. Prediction engine 208 may fuse the sequential user representation and the group-aware user representation via fusion layer 320 to output first embedded fusion 322. The fusion represents a user of the user group.

Moreover, prediction engine 208 can receive a target item embedding, which is an embedded representation of the target item. Prediction engine 208 can also receive a set of homogenous item-item hypergraph embeddings learned from hypergraph neural network 314. The target item embedding and the set of homogenous item-item hypergraph embeddings can be combined to form a combined embedding, illustrated in FIG. 3 as combined embedding 324.

Prediction engine 208 provides the first embedded fusion and the combined embedding to a multilayer perceptron that is configured to learn the final prediction.

As an example, click-through rate prediction given a target user intent sequence S and its group-aware hypergraph [symbol] _{g}^{t}^{ₙ} and item hypergraph [symbol] ᵢ^{t}^{ₙ}, both of them depending on the time sequence T, can be formulated as a function ƒ(u, [symbol] _{g}^{t}^{ₙ}, [symbol] ᵢ^{t}^{ₙ},i)→y for a recommended item i, where y denotes the probability that the user clicks when presented with the target item.

Prediction engine 208 may determine the click-through probability for a plurality of item. The item of the plurality of item having the greatest click-through probability can be selected and presented to a user at a client device.

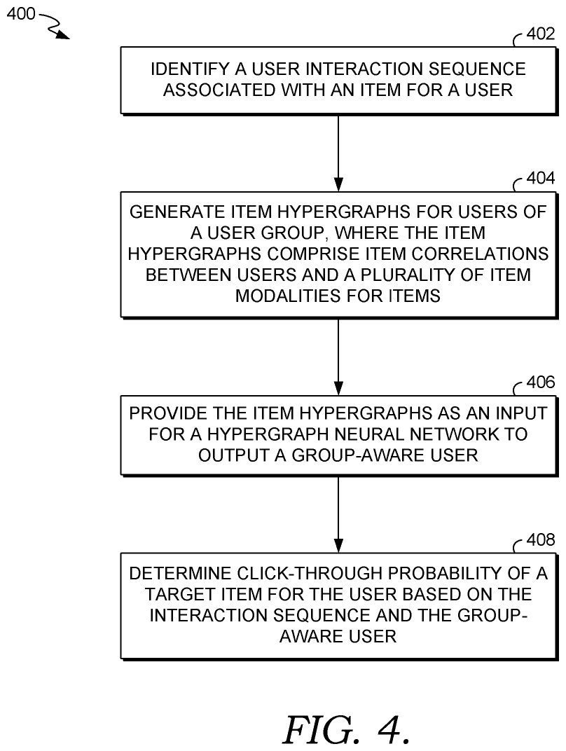

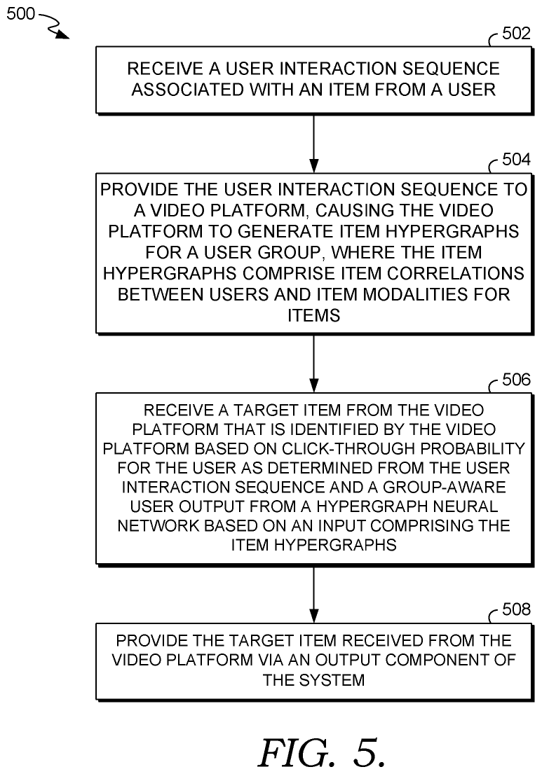

With reference to FIGS. 4 and 5, block diagrams are provided to illustrate methods for determining a click-through prediction and providing a target item based on the click-through rate prediction. The methods may be performed using item providing engine 200. In embodiments, one or more computer storage media having computer-executable instructions embodied thereon that, when executed, by one or more processors, cause the one or more processors to perform the methods 400 and 500.

With reference to FIG. 4 and to FIG. 2, FIG. 4 provides method 400 for determining a click-through rate probability of a target item. At block 402, a user interaction sequence is identified. This can be done using temporal user attention identifier 202. The user interaction sequence can be associated with items for a user within an online platform. In a specific embodiment, the items are videos and the online platform is an online video platform.

At block 404, item hypergraphs for users of a user group are generated. The user group can include the user of block 402. The item hypergraphs may comprise item correlations between user and a plurality of item modalities. The item modalities can be visual, acoustic, and textual, among other possible modalities. The items may be items with which the users have interacted. The item hypergraphs can be generated using item hypergraph generator 206.

In some aspect, at block 404, interest-based user hypergraphs can be generated. Interest-based user hypergraphs can be generated using interest-based user hypergraph generator 204. The interest-based user hypergraphs can be generated for the user group. They may comprise correlations of common user content interest for content of the video platform. Common user content interest may include items or item modalities with which a plurality of user has interacted.

At block 406, the item hypergraphs generated at block 404 are provided as an input to a hypergraph neural network. The hypergraph neural network outputs a group-aware user. The output may include a group-aware user representation, e.g., an embedded representation of the group-aware user. Prediction engine 208 may be used to provide the interest-based user hypergraphs or the item hypergraphs as the input to the hypergraph neural network.

At block 406, a click-through probability of a target item is determined. This can be determined for the user based on the user interaction sequence, e.g., the sequential user representation, and the group-aware user, e.g., the group-aware user representation. Prediction engine 208 may be used to determine the click-through rate probability of the target item. The target item may be presented to the user at a client device based on the click-through rate.

In aspects, the click-through rate probability can be determined from an output of a multilayer perceptron. The inputs to the multilayer perceptron can comprise a first embedded fusion and a combined embedding.

To get the first embedded fusion for determining the click-through probability, the embedded sequential user representation is generated from the user interaction sequence, which may be done after passing the user interaction sequence through an attention layer. An embedded group-aware user representation is also generated, and may be the embedded representation of the group-aware user from the output of the hypergraph neural network. The embedded user interaction sequence, e.g., the embedded user representation and the embedded group-aware representation are fused via a fusion layer to provide the first embedded fusion.

To get the combined embedding for determining the click through probability, a target item embedding can be generated from the target item, e.g., an embedded representation of the target item. An item-item hypergraph embedding is generated from the output of the hypergraph neural network. The target item embedded representation and the item-item hypergraph embedding are combined to provide the combined embedding that is the input to the multilayer perceptron.

Turning now to FIG. 5 and FIG. 2, FIG. 5 illustrates an example method 500 for providing a target item. At block 502, a user interaction sequence is received. The user interaction sequence may be received from an input device of a system, such as a client device. The interaction sequence is associated with user interaction with an online platform, including a video platform, and may be associated with items with which a user has interacted, where the items have been provided by the video platform and received by the system.

At block 504, the user interaction sequence is provided by the system to the video platform. This causes the video platform to generate item hypergraphs for a user group comprising the user. The item hypergraphs generated by the video platform can comprise item correlations between users and item modalities for the items the users have interacted with in the video platform. Item hypergraphs may be generated by the video platform using item hypergraph generator 206.

When the system provides the user interaction sequence, this may also cause the video platform to generate interest-based user hypergraphs for the users of the user group. The interest-based user hypergraphs can comprise user correlations based on common user content interests for content of the video platform. In some cases, the video platform generates a series of interest-based user hypergraphs. The series of interest-based user hypergraphs may be generated based on user interaction sequenced within a series of time slots, including sequential time slots. Interest-based user hypergraphs may be generated by the video platform using item hypergraph generator 206.

At block 506, a target item is received at the client device from the video platform. The target item can be identified by the video platform using prediction engine 208. The target item may be identified by the video platform based on a click-through rate probability determined by the video platform. The click-through rate probability can be determined from the user interaction sequence and a group-aware user. The group-aware user may be output from a hypergraph neural network in response to the item hypergraphs being provided as an input.

In aspects, the click-through rate probability of the target item is determined by the video platform based on a first embedded fusion of an embedded sequential user representation of the user interaction sequence and an embedded group-aware user representation from the group-aware user output from the hypergraph neural network. The embedded sequential user representation can be an output of an attention layer, while the group-aware user representation may be an output of the hypergraph neural network.

The click-through rate may be further determined based on the first embedded fusion and a combined embedding. The combined embedding may be a combination of a target item embedding and an item-item hypergraph embedding output from the hypergraph neural network. The click-through rate probability may be determined by the video platform by inputting the first embedded fusion and the combined embedding into a multilayer perceptron that is configured to output the probability. This can be done using prediction engine 208.

### Example

Existing click-through rate prediction models mostly utilize unimodal datasets. In contrast, the described technology uses multiple modalities for click-through rate prediction. As mentioned, video datasets contain rich multimedia information and include multiple modalities, such as visual, acoustic and textual. This example illustrates a comparison between the described technology and other conventional technologies using three publicly available datasets: Kuaishou, MV1.7M and MovieLens 10M, which are summarized in Table 1.

TABLE 1

| Dataset | #Items | #Users | #Interactions | Sparsity | v. | a. | t. |
|---|---|---|---|---|---|---|---|
| Kuaishou | 3,239,534 | 10,000 | 13,661,383 | 99.98% | 2048 | — | 128 |
| MV1.7M | 1,704,880 | 10,986 | 12,737,619 | — | 128 | 128 | 128 |
| Movielens | 10,681 | 71,567 | 10,000,054 | 99.63% | 2048 | 128 | 100 |

Kuaishou: This dataset is released by Kuaishou. There are multiple interactions between users and micro-videos. Each behavior is also associated with a timestamp, which records when the event happens. The timestamp has been processed to modify the absolute time, but the sequential temporal order is preserved with respect to the timestamp.
Micro-Video 1.7M: In this dataset, the interaction types include “click” and “unclick.” Each micro-video is represented by a 128-dimensional visual embedding vector of its thumbnail. Each user's historical interactions are sorted in chronological order.
MovieLens: The MovieLens dataset is obtained from the Movie-Lens 10M Data. It has been assumed that a user has an interaction with a movie if the user gives it a rating of four or five. A pre-trained ResNet model is used to obtain the visual features from key frames extracted from the micro-video. For acoustic modality, audio tracks are separated with FFmpeg6 and adopt VGGish to learn the acoustic deep learning features. For textual modality, Sentence2Vector is used to derive the textual features from micro-videos' descriptions.

The hypergraph model that can be built from this disclosure is compared with strong baselines from both sequential click-through rate prediction and recommendation. The comparative methods are: (1) GRU4Rec based on RNN (recurrent neural network). (2) THACIL is a personalized micro-video recommendation method for modeling users' historical behaviors, which leverages category-level and item-level attention mechanisms to model the diverse and fine-grained interests respectively. It adopts forward multi-head self-attention to capture the long-term correlation within user behaviors. (3) DSTN learns the interactions between each type of auxiliary data and the target ad, to emphasize more important hidden information, and fuses heterogeneous data in a unified framework. (4) MIMN is a novel memory-based multi-channel user interest memory network to capture user interests from long sequential behavior data. (5) ALPINE is a personalized micro-video recommendation method which learns the diverse and dynamic interest, multi-level interest, and true negative samples. It utilizes a temporal graph-based LSTM network to model users' dynamic and diverse interests from click sequence, and capture uninterested information from the true negative sample. It introduces a user matrix to enhance user interest modeling by incorporating multiple types of interactions. (6) AutoFIS automatically selects important second and third order feature interactions. The proposed methods are generally applicable to many factorization models and the selected important interactions can be transferred to other deep learning models for CTR prediction. (7) UBR4CTR has a retrieval module and it generates a query to search from the whole user behaviors archive to retrieve the most useful behavioral data for prediction. The retrieved data is then used by an attention-based deep network to make the final prediction.

The click-through rate prediction performance is evaluated using two widely used metrics. The first one is Area Under ROC curve (AUC) which reflects the pairwise ranking performance between click and non-click samples. The other metric is log loss (e.g., logistic loss or cross-entropy loss). Log loss is used to measure the overall likelihood of the test data and has been widely used for the classification tasks.

Table 1: The overall performance of different models on Kuaishou, Micro-Video 1.7M and MovieLens datasets is provided in percentile.

TABLE 2

| | Kuaishou | | MV1.7M | | MovieLens | |
|---|---|---|---|---|---|---|
| Method | AUC | Logloss | AUC | Logloss | AUC | Logloss |
| GRU4Rec | 0.7367 | 0.5852 | 0.7522 | 0.6613 | 0.7486 | 0.6991 |
| THACIL | 0.6640 | 0.5793 | 0.6842 | 0.6572 | 0.6720 | 0.6791 |
| DSTN | 0.7722 | 0.5672 | 0.7956 | 0.6492 | 0.8008 | 0.6162 |
| MIMN | 0.7593 | 0.5912 | 0.7486 | 0.6862 | 0.7522 | 0.6751 |
| ALPINE | 0.6840 | 0.5632 | 0.7130 | 0.6591 | 0.7390 | 0.6163 |
| AutoFis | 0.7870 | 0.5756 | 0.8010 | 0.5404 | 0.7983 | 0.5436 |
| UBR4CTR | 0.7520 | 0.5710 | 0.8070 | 0.5605 | 0.8050 | 0.5663 |
| Hypergraph | 0.8120 | 0.5548 | 0.8670 | 0.5160 | 0.8360 | 0.5380 |
| Model | | | | | | |
| Improvement | 3.18% | 1.49% | 7.43% | 4.51% | 3.85% | 1.03% |
| (%) | | | | | | |

Table 2 presents the AUC score and log loss values for all models. When different modalities are used with the hypergraph model, all models show an improved performance when the same set of modalities containing visual, acoustic and textual features are used in MV1.7M and MovieLens(10M). It is also noted that: the performance of the hypergraph model has improved significantly compared to the best performing baselines. AUC is improved by 3.18%, 7.43% and 3.85% on three datasets, respectively, and log loss is improved by 1.49%, 4.51% and 1.03%, respectively. Moreover, the improvement by the hypergraph model demonstrates that the unimodal features do not embed enough temporal information for which the baselines cannot effectively exploit. The baseline methods cannot perform well if the patterns that they try to capture do not contain multi-modal features in the user-item interaction sequence.

Having described an overview of embodiments of the present technology, an example operating environment in which embodiments of the present technology may be implemented is described below in order to provide a general context for various aspects. Referring initially to FIG. 6, in particular, an example operating environment for implementing embodiments of the present technology is shown and designated generally as computing device 600. Computing device 600 is but one example of a suitable computing environment and is not intended to suggest any limitation as to the scope of use or functionality of the technology. Neither should computing device 600 be interpreted as having any dependency or requirement relating to any one or combination of components illustrated.

The technology of the present disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 6, computing device 600 includes bus 610 that directly or indirectly couples the following devices: memory 612, one or more processors 614, one or more presentation components 616, input/output ports 618, input/output components 620, and illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component, such as a display device, to be an I/O component. As another example, processors may also have memory. Such is the nature of the art, and it is again reiterated that the diagram of FIG. 6 merely illustrates an example computing device that can be used in connection with one or more embodiments of the present technology. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information, such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile or nonvolatile memory. The memory may be removable, non-removable, or a combination thereof. Example hardware devices include solid-state memory, hard drives, optical-disc drives, etc. Computing device 600 includes one or more processors that read data from various entities such as memory 612 or I/O components 620. Presentation component(s) 616 present data indications to a user or other device. Examples of presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, and so forth.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including” or “having” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the described schematics, it is understood that the techniques described may be extended to other implementation contexts.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated the accompanying drawings is to be interpreted as illustrative and not in a limiting sense.

Some example aspects of the technology that may be practiced from the forgoing disclosure include the following:

Aspect 1: A method performed by one or more computer processors or one or more computer storage media storing computer-readable instructions that when executed by a processor, cause the processor to perform operations for click prediction within a video platform, the method or operations comprising: identifying a user interaction sequence associated with items for a user within a video platform; generating item hypergraphs for users of a user group that includes the user, the item hypergraphs comprising item correlations between users and a plurality of item modalities for the items the users have interacted with in the video platform; providing the item hypergraphs as an input for a hypergraph neural network to output a group-aware user; and determining a click-through rate probability of a target item for the user based on the user interaction sequence and the group-aware user.

Aspect 2: Aspect 1, wherein determining the click-through rate probability of the target item further comprises: generating an embedded sequential user representation from the user interaction sequence; generating an embedded group-aware user representation from the group-aware user output of the hypergraph neural network; and fusing the embedded user interaction sequence representation and the embedded group-aware user representation to generate a first embedded fusion.

Aspect 3: Aspect 2, wherein determining the click-through rate probability of the target item further comprises: generating a target item embedded representation of the target item; generating an item-item hypergraph embedding from an output of the hypergraph neural network; and combining the target item embedded representation and the item-item hypergraph embedding to generate a combined embedding, wherein the first embedded fusion and the combined embedding are provided to a multilayer perceptron (MLP) configured to output the click-through rate probability of the target item.

Aspect 4: Any of Aspects 1-3, further comprising generating interest-based user hypergraphs for the users of the user group, the interest-based user hypergraphs comprising user correlations based on common user content interests for content of the video platform, wherein the interest-based user hypergraph is included in the input for the hypergraph neural network.

Aspect 5: Any of Aspects 1-4, further comprising: identifying time slots, each time slot of the time slots comprising a portion of a total number of user interaction sequences that includes the user interaction sequence; and generating a series of interest-based user hypergraphs that includes the interest-based user hypergraph for the user group, the series of interest-based user hypergraphs generated based on the time slots, wherein the series of interest-based user hypergraphs is comprised within the input for the hypergraph neural network.

Aspect 6: Any of Aspects 1-5, further comprising providing the target item for display by the video platform based on the click-through rate probability.

Aspect 7: Any of Aspects 1-6, wherein the plurality of item modalities comprise textual, visual, and acoustic information associated with items.

Aspect 8: A system for click prediction within a video platform, the system comprising: at least one processor; and one or more computer storage media storing computer-readable instructions that when executed by a processor, cause the processor to perform a method comprising: receiving a user interaction sequence associated with items from a user of a video platform; providing the user interaction sequence to the video platform, wherein providing the user interaction sequence causes the video platform to generate item hypergraphs for a user group comprising the user, the item hypergraphs comprising item correlations between users and item modalities for the items the users have interacted with in the video platform; receiving a target item from the video platform, wherein the target item is identified by the video platform based on a click-through rate probability for the user, the click-through rate probability determined from the user interaction sequence and a group-aware user, the group-aware user being output from a hypergraph neural network in response to the item hypergraphs being provided as an input; and providing the target item received from the video platform via an output component of the system.

Aspect 9: Aspect 8, wherein the click-through rate probability of the target item is determined by the video platform based on a first embedded fusion of an embedded sequential user representation of the user interaction sequence and an embedded group-aware user representation from the group-aware user output from the hypergraph neural network.

Aspect 10: Aspect 9, wherein the click-through rate probability of the target item is further determined by the video platform based on a combined embedding of a target item embedded representation of the target item and an item-item hypergraph embedding output from the hypergraph neural network.

Aspect 11: Aspect 10, wherein the click-through rate probability for the target item is determined by the video platform using a multilayer perceptron (MLP) configured to output the click-through rate probability from an input of the first embedded fusion and the combined embedding.

Aspect 12: Any of Aspects 8-11, wherein providing the user interaction sequence to the video platform causes the video platform to generate interest-based user hypergraphs for the users of the user group, the interest-based user hypergraphs comprising user correlations based on common user content interests for content of the video platform, wherein the interest-based user hypergraph is included in the input for the hypergraph neural network.

Aspect 13: Any of Aspects 8-12, wherein the user interaction sequence is included in a time slot comprising a portion of a total number of user interaction sequences, and wherein a series of interest-based user hypergraphs that includes the interest-based user hypergraph is generated by the video platform from time slots, the series of interest-based user hypergraphs comprised within the input for the hypergraph neural network.

What is claimed is:

1. One or more computer storage media storing computer-readable instructions that when executed by a processor, cause the processor to perform operations for click prediction within a video platform, the operations comprising: identifying a user interaction sequence associated with items for a user within a video platform; generating item hypergraphs for users of a user group that includes the user, the item hypergraphs comprising item correlations between users and a plurality of item modalities for the items the users have interacted with in the video platform; providing the item hypergraphs as an input for a hypergraph neural network to output a group-aware user; and determining a click-through rate probability of a target item for the user based on the user interaction sequence and the group-aware user.

2. The media of claim 1, wherein determining the click-through rate probability of the target item further comprises: generating an embedded sequential user representation from the user interaction sequence; generating an embedded group-aware user representation from the group-aware user output of the hypergraph neural network; and fusing the embedded user interaction sequence representation and the embedded group-aware user representation to generate a first embedded fusion.

3. The media of claim 2, wherein determining the click-through rate probability of the target item further comprises: generating a target item embedded representation of the target item; generating an item-item hypergraph embedding from an output of the hypergraph neural network; and combining the target item embedded representation and the item-item hypergraph embedding to generate a combined embedding, wherein the first embedded fusion and the combined embedding are provided to a multilayer perceptron (MLP) configured to output the click-through rate probability of the target item.

4. The media of claim 1, further comprising generating interest-based user hypergraphs for the users of the user group, the interest-based user hypergraphs comprising user correlations based on common user content interests for content of the video platform, wherein the interest-based user hypergraph is included in the input for the hypergraph neural network.

5. The media of claim 1, further comprising: identifying time slots, each time slot of the time slots comprising a portion of a total number of user interaction sequences that includes the user interaction sequence; and generating a series of interest-based user hypergraphs that includes the interest-based user hypergraph for the user group, the series of interest-based user hypergraphs generated based on the time slots, wherein the series of interest-based user hypergraphs is comprised within the input for the hypergraph neural network.

6. The media of claim 1, further comprising providing the target item for display by the video platform based on the click-through rate probability.

7. The media of claim 1, wherein the plurality of item modalities comprise textual, visual, and acoustic information associated with items.

8. A computerized method performed by one or more processors for generating a model for click prediction within a video platform, the operations comprising: identifying a user interaction sequence associated with items for a user within a video platform; generating item hypergraphs for users of a user group that includes the user, the item hypergraphs comprising item correlations between users and a plurality of item modalities for the items the users have interacted with in the video platform; providing the item hypergraphs as an input for a hypergraph neural network to output a group-aware user; and determining a click-through rate probability of a target item for the user based on the user interaction sequence and the group-aware user.

9. The method of claim 8, wherein determining the click-through rate probability of the target item further comprises: generating an embedded sequential user representation from the user interaction sequence; generating an embedded group-aware user representation from the group-aware user output of the hypergraph neural network; and fusing the embedded user interaction sequence representation and the embedded group-aware user representation to generate a first embedded fusion.

10. The method of claim 9, wherein determining the click-through rate probability of the target item further comprises: generating a target item embedded representation of the target item; generating an item-item hypergraph embedding from an output of the hypergraph neural network; and combining the target item embedded representation and the item-item hypergraph embedding to generate combined embedding, wherein the first embedded fusion and the combined embedding are provided to a multilayer perceptron (MLP) configured to output the click-through rate probability of the target item.

11. The method of claim 8, further comprising generating interest-based user hypergraphs for the users of the user group, the interest-based user hypergraphs comprising user correlations based on common user content interests for content of the video platform, wherein the interest-based user hypergraph is included in the input for the hypergraph neural network.

12. The method of claim 8, further comprising: identifying time slots, each time slot of the time slots comprising a portion of a total number of user interaction sequences that includes the user interaction sequence; and generating a series of interest-based user hypergraphs that includes the interest-based user hypergraph for the user group, the series of interest-based user hypergraphs generated based on the time slots, wherein the series of interest-based user hypergraphs is comprised within the input for the hypergraph neural network.

13. The method of claim 8, further comprising providing the target item for display by the video platform based on the click-through rate probability.

14. The method of claim 8, wherein the plurality of item modalities comprise textual, visual, and acoustic information associated with items.

15. A system for click prediction within a video platform, the system comprising: at least one processor; and one or more computer storage media storing computer-readable instructions that when executed by a processor, cause the processor to perform a method comprising: receiving a user interaction sequence associated with items from a user of a video platform; providing the user interaction sequence to the video platform, wherein providing the user interaction sequence causes the video platform to generate item hypergraphs for a user group comprising the user, the item hypergraphs comprising item correlations between users and item modalities for the items the users have interacted with in the video platform; receiving a target item from the video platform, wherein the target item is identified by the video platform based on a click-through rate probability for the user, the click-through rate probability determined from the user interaction sequence and a group-aware user, the group-aware user being output from a hypergraph neural network in response to the item hypergraphs being provided as an input; and providing the target item received from the video platform via an output component of the system.

16. The system of claim 15, wherein the click-through rate probability of the target item is determined by the video platform based on a first embedded fusion of an embedded sequential user representation of the user interaction sequence and an embedded group-aware user representation from the group-aware user output from the hypergraph neural network.

17. The system of claim 16, wherein the click-through rate probability of the target item is further determined by the video platform based on a combined embedding of a target item embedded representation of the target item and an item-item hypergraph embedding output from the hypergraph neural network.

18. The system of claim 17, wherein the click-through rate probability for the target item is determined by the video platform using a multilayer perceptron (MLP) configured to output the click-through rate probability from an input of the first embedded fusion and the combined embedding.

19. The system of claim 15, wherein providing the user interaction sequence to the video platform causes the video platform to generate interest-based user hypergraphs for the users of the user group, the interest-based user hypergraphs comprising user correlations based on common user content interests for content of the video platform, wherein the interest-based user hypergraph is included in the input for the hypergraph neural network.

20. The system of claim 15, wherein the user interaction sequence is included in a time slot comprising a portion of a total number of user interaction sequences, and wherein a series of interest-based user hypergraphs that includes the interest-based user hypergraph is generated by the video platform from time slots, the series of interest-based user hypergraphs comprised within the input for the hypergraph neural network.
